(19) United States
(12) Patent Application Publication
(10) Pub. No.: US 2022/0042429 A1
(43) Pub. Date: Feb. 10, 2022

(54) EQUIPMENT LUBRICANT WATER INGRESS MEASUREMENT SYSTEM AND METHOD

(71) Applicant: Cameron International Corporation, Houston, TX (US)

(72) Inventors: Alejandro Camacho Cardenas, Houston, TX (US); Sean Clarke, Houston, TX (US)

(21) Appl. No.: 16/989,440

(22) Filed: Aug. 10, 2020

(51) Int. Cl. F01M 1/02

(52) U.S. Cl. CPC F01M 1/02; F16N 2250/04; F16N 2200/20; F01M 2001/0215

(57) ABSTRACT

A lubricant system for providing a lubricant to a machine includes one or more sensors configured to measure a physical property of the lubricant system, and a controller in communication with the one or more sensors. The controller is configured to receive measurements of the physical property from the one or more sensors, determine an operating state of at least a portion of the lubricant system based at least in part on the measurements of the physical property, and determine a presence of water in the lubricant based at least in part on the measurements of the physical property.

### BACKGROUND

Oil and gas drilling systems include several different types of large equipment, such as pumps. This equipment is generally lubricated using an oil lubricant that is cycled through a lubrication circuit therein. Care is taken to ensure that the lubricant is prevented from mixture with other fluids, such as water. Water ingress, in particular, can cause premature wear and early equipment failures, if not mitigated. Accordingly, there are various different devices that are implemented to detect water contamination (ingress) in the lubricant. However, such devices may increase the complexity of the machine, resulting in new points prone to failure, which can impair the overall operation of the machine.

### SUMMARY

Embodiments of the disclosure may provide a lubricant system for providing a lubricant to a machine. The system includes one or more sensors configured to measure a physical property of the lubricant system, and a controller in communication with the one or more sensors. The controller is configured to receive measurements of the physical property from the one or more sensors, determine an operating state of at least a portion of the lubricant system based at least in part on the measurements of the physical property, and determine a presence of water in the lubricant based at least in part on the measurements of the physical property.

Embodiments of the disclosure may also provide a method for detecting water in a lubricant of a lubrication system. The method includes measuring a physical property of the lubricant or a physical property associated with a component of the lubrication system using one or more sensors, determining an operating state of at least a portion of the lubrication system based at least in part on the measurement of the physical property, and determining a presence of water in the lubricant based at least in part on the measurement of the physical property.

Embodiments of the disclosure may also provide a method for detecting water in a lubricant of a lubrication system. The method includes measuring a pressure of the lubricant in the lubrication system using a first pressure sensor, measuring a pressure differential of the lubricant in the lubrication system across a filter using the first pressure sensor and a second pressure sensor, measuring a current draw of a lubricant pump of the lubrication system using an ammeter coupled to the lubricant pump, comparing the pressure of the lubricant to an expected pressure of the lubricant in the absence of a presence of water in the lubricant, comparing the pressure differential of the lubricant to an expected pressure differential of the lubricant in the absence of the presence of water in the lubricant, comparing the current draw of the lubricant pump to an expected current draw of the lubricant pump in the absence of the presence of water in the lubricant, determining an amount of water in the lubricant based on a combination of the pressure of the lubricant in comparison to the expected pressure, the pressure differential of the lubricant in comparison to the expected pressure differential, and the current draw of the lubricant pump in comparison to the expected current draw, and taking one or more mitigating actions based at least in part on the determination of the amount of water in the lubricant.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a simplified schematic view of a machine including a lubrication system, according to an embodiment.

FIG. 2 illustrates a flowchart of such a method, according to an embodiment.

FIG. 3 illustrates a flowchart of an example of acquiring the sensor measurements and determining water ingress based on the sensor measurements, according to an embodiment.

FIG. 4 illustrates a flowchart of another example of acquiring the sensor measurements and determining water ingress based on the sensor measurements, according to an embodiment.

FIG. 5 illustrates a flowchart of another example of acquiring the sensor measurements and determining water ingress based on the sensor measurements, according to an embodiment.

FIG. 6A illustrates a schematic view of a prognostic health management (PHM) system, according to an embodiment.

FIG. 6B illustrates a schematic view of a rig-level prognostic health management (PHM) system that incorporates the water ingress measurements and produces the health index, as part of a larger regime for monitoring drilling rig health, according to an embodiment.

FIG. 7 illustrates an example of such a computing system 700, in accordance with some embodiments.

### DETAILED DESCRIPTION

Reference will now be made in detail to specific embodiments illustrated in the accompanying drawings and figures. In the following detailed description, numerous specific details are set forth in order to provide a thorough understanding of the embodiments described herein. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the techniques herein is for the purpose of describing particular embodiments only and is not intended to be limiting. As used in the description of the techniques herein and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

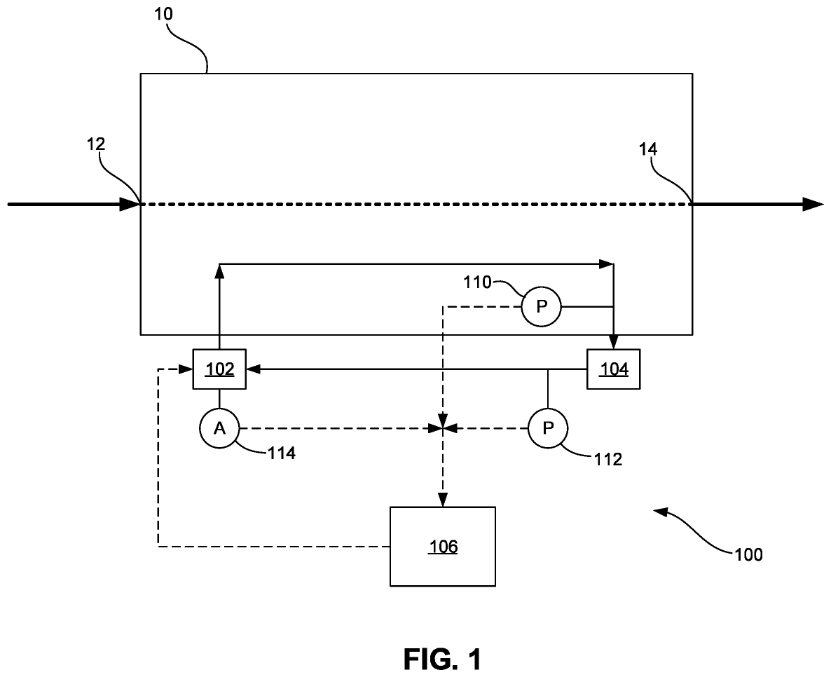

FIG. 1 illustrates a simplified schematic view of a machine 10 including a lubrication system 100, according to an embodiment. The machine 10 may be a pump, such as a mud pump that may be employed on a drilling rig. The machine 10 may be any number of other types of machines, however, and thus the reference to a mud pump on a drilling rig should be considered as merely an example. In this embodiment, the machine 10 may receive a fluid at an inlet 12 and provide a pressurized fluid at an outlet 14. The pressurized fluid may then, for example, be injected into a well or used for any other purpose.

The lubrication system 100 may include a lubricant pump 102, a filter 104, and a controller 106. The lubricant pump 102 may be an electric pump configured to pump the lubricant through one or more areas of the machine 10 that are configured to accept lubricant to maintain low friction levels therein. The filter 104 may be configured to receive the lubricant after (or before, in some embodiments) it courses through the lubricated areas of the machine. The filter 104 may be configured to remove solid particulate matter from the lubricant. The lubricant may then proceed back to the pump 102 and the cycle restarts. It will be appreciated that other components, such as heat exchangers, valves, etc. may be employed in the lubrication system 100.

The lubrication system 100 may also include one or more sensors. For example, the lubrication system 100 may include a first pressure sensor 110, a second pressure sensor 112, and an ammeter 114. The lubrication system 100 may also include one or more other sensors, such as pump speed sensors, temperature sensors, etc. In some embodiments, the first pressure sensor 110 may be between the pump 102 and the filter 104 (i.e., “upstream” of the filter 104), and the filter 104 may be positioned between the first pressure sensor 110 and the second pressure sensor 112 (i.e., the second pressure sensor 112 is “downstream” of the filter 104). The sensors 110, 112 may be sensitive to fluid level in the system, and therefore may also be used to quantify the amount of water ingress into the lubricant, in addition to measuring the lubricant fluid level in the system 100, as will be described in greater detail below. In some embodiments, the sensors 110, 112 may be positioned at locations where sensitivity to fluid level is at a maximum (e.g., at a lower level, vertically, than might otherwise be used).

Further, the ammeter 114 may be configured to determine a current drawn by the pump 102. The current draw may be converted into power consumption by the pump 102, using the controller 106 or another device. Moreover, the current drawn by the pump 102 may be compared with the speed of the pump 102, e.g., by the controller 106, in order to determine a resistance to movement within the pump 102, which may change according to the properties of the lubricant being pumped. As will be described below, this may also or instead be used to determine the presence of water in the lubricant.

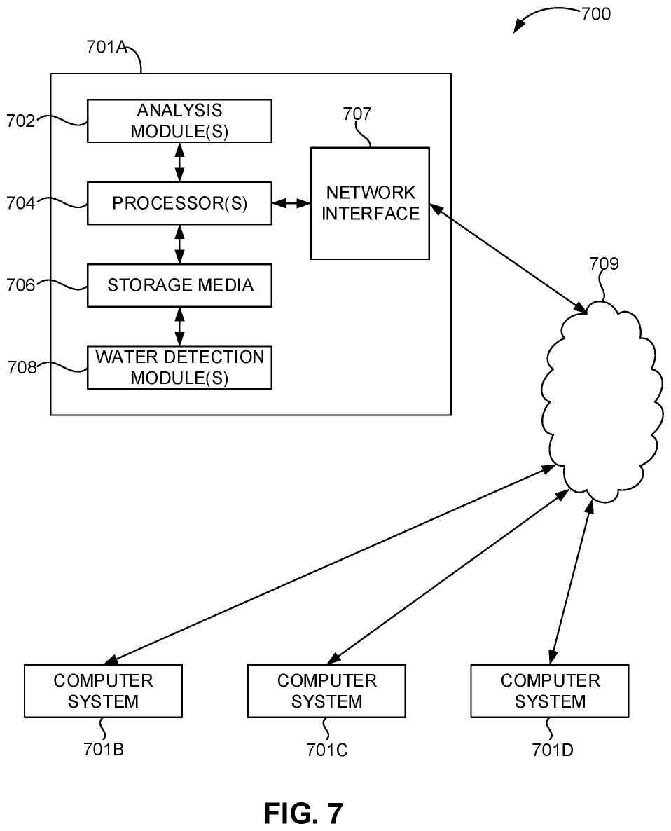

Considering the controller 106 in greater detail, the controller 106 may be coupled to the sensors 110, 112, 114 and the pump 102, as indicated by dashed lines. For example, the controller 106 may be configured to receive signals from the sensors 110, 112, 114 that represent the measurement taken by the sensors 110, 112, 114, e.g., with the signal having a voltage proportional to the measured value. The controller 106 may also be configured to communicate with the pump 102, e.g., so as to receive speed information therefrom and/or to control one or more operating parameters of the pump 102, e.g., speed. The controller 106 may also communicate with any other sensors provided by the system 100 and/or a rig controller that controls other equipment on the rig. The controller 106 may include one or more computer systems, or a part of a computer system, such as the computer system discussed below with reference to FIG. 7.

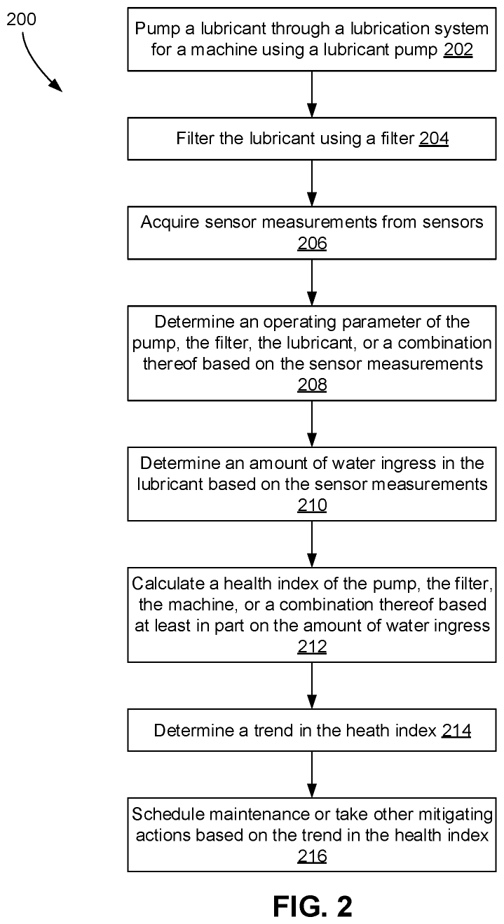

Accordingly, the controller 106 may be configured to perform a method (e.g. operations) by executing code stored on a computer-readable medium. FIG. 2 illustrates a flowchart of such a method 200, according to an embodiment. The method 200, in particular, may be configured for detecting water in a lubricant of a lubrication system 100. It will be appreciated that detecting the presence of water can be a binary determination (yes/no as to the presence of water in the lubricant), or may be a quantitative inference or calculation of a percentage by weight or volume of the fluid in the lubrication system 100 that is water, or by an actual weight or volume of water in the system 100.

The method 200 may include pumping the lubricant through the lubrication system for the machine 10, using the lubricant pump 102, as at 202. Further, the lubricant may be filtered using a filter 104, as at 204. These two operations may be generally simultaneous: as fluid is pumped, fluid is forced through the filter 104 and filtered.

Before, during, and/or after pumping at 202 and filtering at 204, the method 200 may include acquiring sensor measurements, as at 206. From these sensor measurements, the method 200 may include determining an operating parameter of the pump, the filter, the lubricant, or a combination thereof, as at 208. For example, the sensor measurements may be acquired by sensors positioned in the lubricant system 100, e.g., the pressure sensors 110 and/or 112 and/or the ammeter 114. The sensors 110, 112 may detect a pressure of the lubricant in a line or reservoir, which may be employed, for example, to determine an amount of lubricant in the system 100, e.g., an operating parameter of the lubricant in the system 100. Further, a pressure differential between the sensors 110, 112 may determine a pressure drop across the lubricant filter 104, which may be considered an operating parameter of the filter 104. Increased pressure drop may be indicative of clogging (or another type of restriction) of the filter 104, e.g., by particulate matter. The ammeter 114 may detect an electrical current drawn by the pump 102, which may be employed to calculate power consumption by the pump 102. The power consumption may be correlated to pump speed, pressure increase, or any other operating parameter in order to determine an operating efficiency of the pump 102, which may in turn be indicative of pump health.

Additionally, one, some, or each of these measurements may be employed to determine water ingress into the lubricant, as at 210. The different measurements and their representation of water ingress into the lubricant are discussed in greater detail below. In general, however, each of the measurements acquired at 206 may be employed not only to determine the operating parameter of the associate component of the system 100, but also to determine the presence (e.g., quantity) of water in the lubricant. Thus, sensors that may already be implemented in some systems may be employed for a secondary purpose, which is implemented by the controller 106.

In some embodiments, two or more types of sensor measurements may be combined to provide a robust and precise determination of water ingress. For example, as will be discussed below, the sensor measurements may be pressure, pressure differential, current drawn by the pump 102, temperature, etc. Each of these may provide a different technique for determining the amount of water present in the lubricant fluid (if any). Accordingly, embodiments of the present method may employ two or more such types of sensor measurements in a voting scheme to avoid sensor malfunction causing unnecessary operational delays in the machine 10 (e.g., detecting/avoiding outliers that may be due to sensor malfunctions). Such multiple measurement types may also be used for redundancy or otherwise provided to avoid false determinations of water presence (or lack thereof).

The method 200 may also include calculating a health index of the pump 102, the filter 104, the machine 10, or a combination thereof based at least in part on the amount of water ingress in the lubricant, as at 212. For example, water ingress into the lubricant system 100 may impair the ability of the lubricant to lubricate the machine 10 components. Accordingly, the controller 106 may increase the calculated rate of wear (or, relatedly, reduce the life cycle) of the machine 10 depending on the presence and amount of water in the lubricant. Further, pumping water instead of lubricant may not only be evidence of wear on the components of the machine 10, e.g., that seals that are provided to prevent water ingress (e.g., from the fluid being pumped by the machine 10 between the inlet 12 and outlet 14) are failing, etc., but may itself negatively affect the lifecycle of the pump 102, the machine 10, and/or filter 104. This may also represent a negative impact on the health of the machine 10. Thus, a health index may be calculated as a combination of any of these factors, providing a holistic view of the machine 10 and its lubrication system 100, for example.

Further, the health index may be tracked, e.g., over time, and a trend determined, as at 214. This trend may be employed to anticipate potential failures in the machine 10 and/or its lubrication system 100. Accordingly, the method 200 may include scheduling maintenance or taking other mitigating actions (e.g., sounding or displaying an alert, sending warning messages, displaying a color-coded health index, shutting the machine 10 down, etc.) based on the trend in the health index, as at 216. For example, the mitigating actions may be calculated so as to avert the anticipated potential failures. In some embodiments, the health index may be integrated into a larger health indexing system that monitors the health of several components or systems of the drilling rig, as will be described in greater detail below.

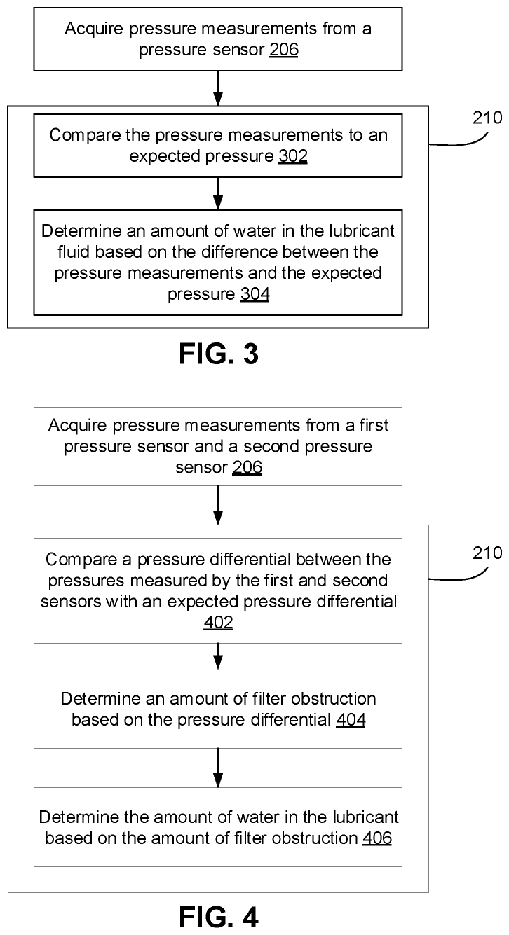

FIG. 3 illustrates a flowchart of an example of acquiring the sensor measurements at 206 and determining water ingress at 210, according to an embodiment. As shown, this example, acquiring sensor measurements at 206 includes acquiring one or more pressure measurements from a pressure sensor, e.g., the first pressure sensor 110 of FIG. 1. In order to use this pressure measurement to determine water ingress at 210, the method 200 further includes comparing the pressure measurements to an “expected” pressure, as at 302. The expected pressure is the pressure that is measured in the system 100 by the particular sensor if there were no water in the lubricant. Since water and (oil-based) lubricant have different densities, the pressure of the fluid at a given point in the system 100 may vary at least partially as a function of the density. Accordingly, by comparing the two values, i.e., measured and expected pressure, the presence of water can be detected. Further, the method 200, e.g., as implemented by the controller 106, may use this differential to calculate an amount of water (e.g., a percentage by volume) in the lubricant, as at 304.

In general, pressure sensors in lubrication systems may collect measurements while equipment is operating, and these measurements are used to determine the operating condition of the filter and the lubricant pump. For water ingress detection purposes, the measurements may be captured concurrently with the operation of the equipment (e.g., at the same time as the primary purpose to detect pump and/or filter functioning). Alternatively, also for water ingress detection purposes, the pressure sensor 112 may be employed to measure lubricant pressure when the machine 10 and/or lubricant pump 102 are off, such that the lubricant is in a settled condition. In some embodiments, water ingress detection may be based on measurements at both times.

FIG. 4 illustrates a flowchart of another example of acquiring the sensor measurements at 206 and determining water ingress at 210, according to an embodiment. In this example, acquiring sensor measurements at 206 includes acquiring one or more pressure measurements from two sensors (e.g., first and second pressure sensors 110, 112), one upstream of the filter 104 and one downstream from the filter 104. In such an embodiment, the pressure differential between the two pressures measured may be operative. Accordingly, a comparison of the two pressures measured may be made to calculate the measured pressure differential. The method 200 may then include comparing the measured pressure differential with an expected pressure differential, as at 402. The expected pressure differential is the pressure differential that is seen in the absence of water ingress. For example, the filter 104 may be at least partially made from a material that swells in the presence of water but does not swell in the presence of oil-based lubricant. Accordingly, the filter 104 may obstruct the flow of lubricant generally proportional to the amount of water that is contained therein.

The method 200 may thus include determining an amount of filter obstruction based on the measured pressure differential, as at 404. Since the filter obstruction is at least partially a function of water ingress, the method 200 may then include determining an amount of water in the lubricant (e.g., as a portion of the lubricant volume or total fluid volume) based at least partially on the filter 104 obstruction as calculated by the pressure differential across the filter 104, as at 406.

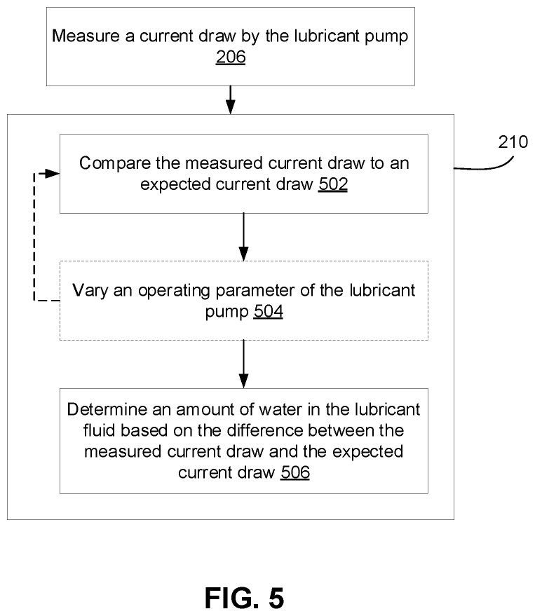

FIG. 5 illustrates a flowchart of another example of acquiring the sensor measurements at 206 and determining water ingress at 210, according to an embodiment. In this example, the sensor measurements are taken using the ammeter 114 coupled to the lubricant pump 102. In particular, the current drawn by the pump 102 is measured at 206. The current drawn may be representative of pumping efficiency, which may in turn be affected by the properties of the fluid that is being pumped. For example, a pump that pumps a more viscous or dense fluid may operate at a lower speed or generate a lower pressure head than a pump that pumps a less viscous or dense fluid. The density and/or viscosity of the fluid being pumped may be calculated based on the power consumption, which may, in turn, be calculated from the current drawn by the pump 102. Since water and oil-based lubricants generally have different viscosities and densities, which may each be known, the current draw measurement may enable a calculation of the density and viscosity of the fluid, and from that, a calculation of the relative amount of oil (lubricant) and water. It will be appreciated that the temperature of the fluid may also be a factor in this calculation, and thus temperature sensors as well as pump speed/pressure measurements from speed/pressure sensors may also be employed along with the current measurement.

Accordingly, the controller 106 may be configured to compare the measured current draw to an expected current draw at a particular operating parameter (e.g., speed or pressure), as at 502. The expected current draw is the current drawn by the pump 102 at the operating parameter when no water is present in the lubricant. Departures from the expected current draw may indicate that the density or viscosity of the lubricant has changed, and water ingress may be inferred as the cause. The quantity of water ingress may be determined based on the value of the difference between the expected current draw and the measured current draw.

The pump 102 may be a conventional pump or may instead be a pump that is more sensitive to fluid type. For example, the pump 102 may include two pumps: one that is sensitive to fluid type and one that is less sensitive. The two pumps may operate in parallel or in series, with measurements indicating water ingress being taken from the sensitive pump, or only on command (e.g., temporarily to determine fluid composition). The pump 102 may also be positioned at a variety of locations. For example, the pump 102, its intake, or its outlet, may be positioned proximal to one or more seals or other locations considered likely to be a source of water ingress.

Further, power consumption monitoring via the ammeter 114 measuring current drawn by the pump 102 may be conducted concurrently with the primary function, which is to monitor amperage and/or power usage to detect issues with pump operation. Alternatively, the current measured may be used intermittently to detect water ingress, e.g., automatically when the pump 102 reaches certain operating setpoints that are known to be sensitive to fluid composition. In other embodiments, a combination of these regimes could be used.

In some embodiments, the operating parameter (e.g., speed) of the pump 102 may be varied, as at 504. For example, some operating parameters may be more sensitive to fluid properties, and thus operating the pump 102 at these setpoints may provide a more accurate calculation of the presence and/or quantity of water in the lubricant. The varying of the operating parameter may occur across a range of setpoints, e.g., for multiple measurements at multiple setpoints, e.g., to generate a several datapoints of power consumption responses from which to calculate the fluid properties (e.g., based on an average, or certain preferential setpoints). Based on the measured current draw, e.g., in comparison to the expected current draw, the amount of water in the lubricant may be calculated as at 506.

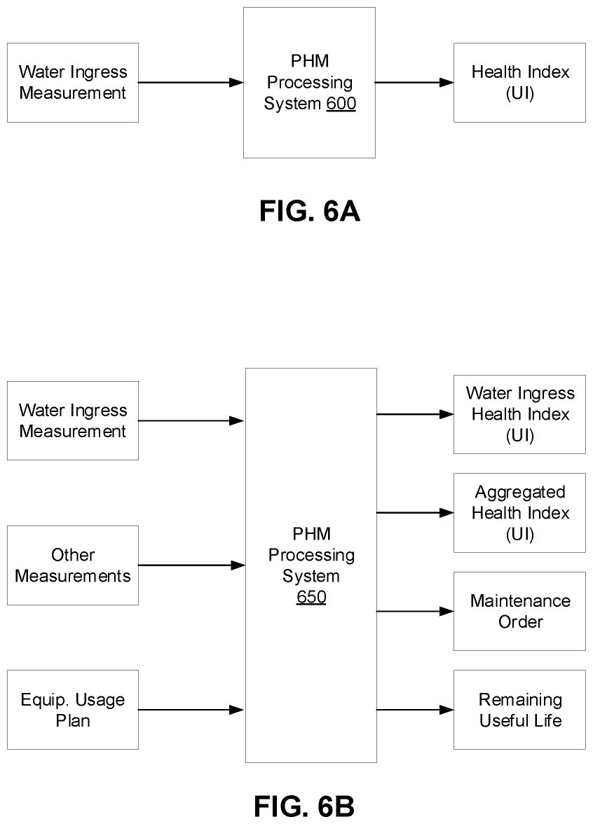

FIG. 6A illustrates a schematic view of a prognostic health management (PHM) system 600, according to an embodiment. The PHM system 600 may receive information from the sensors 110, 112, 114 and calculate the aforementioned health index based on the sensor measurements. Further, multiple health indexes can be calculated, e.g., for different components of the system 100 and/or the machine 10. Continuous monitoring of the health index over time may yield information of the progressive degradation of the machine 10 and/or its components.

FIG. 6B illustrates a schematic view of a rig-level prognostic health management (PHM) system 650 that incorporates the water ingress measurements and produces the health index, as part of a larger regime for monitoring drilling rig health, according to an embodiment. As shown, the PHM 650 may receive water ingress measurements, other measurements, and equipment usage plans as input. These may all be considered factors in determining an operational life (e.g., remaining) of various components of the drilling rig. For example, the PHM 650 may output the health index (based on the water ingress) in a user interface (UI), an aggregated health index, which may be based on various other, non-water related measurements, produce a maintenance order to avoid failures in rig equipment, and plan a remaining useful life for the rig equipment.

Further, the health index can be integrated into a larger rig equipment health monitoring system that tracks the health index over time and gives notification and/or alarms when certain thresholds are met. Further, the rig equipment health monitoring system may calculate and track the deterioration rate of the health index and anticipate the timing when thresholds are expected to be exceeded. Indeed, embodiments may determine a point in time, or the amount of activity performed, e.g., until reaching the anticipated threshold.

In still further aspects, the system may relate the progression of deterioration of the health index (and thus the equipment being monitored) to environmental conditions. The health index tracking system can record environmental variables that could alter water ingress such as temperature, precipitation, humidity, etc. The impact these variables have on health index can be later used to anticipate health index/mechanical degradation on future environmental conditions.

The system may also relate the progression of deterioration of the health index to operating conditions. The health index tracking system can record operating variables of the machine 10 (such as load, speed, temperature, duty-cycle, type of mud, solids content, etc.) to correlate deterioration patterns against usage. Further, the system can use deterioration patters associated to specific usage and/or operating conditions to fine-tune the anticipation of exceeding thresholds (i.e. remaining useful life prediction). Trigger action items related to the health of pumping equipment, such as maintenance or replacement, may also be determined. Upon the breach of one or more health index thresholds, the system can opt to notify a user, shut down equipment, or allow equipment to run on diminished capabilities and/or performance.

Further, the system allows for re-setting and/or identification of maintenance being performed and/or a new pumping equipment being installed (e.g., the system can be updated regarding a new healthy state being introduced such as replaced oil or replaced filters). The health index obtained from this method can be used in tandem with HI obtained from other equipment on the drilling rig. Aggregated health indexes can be computed from all and any health indexes on the drilling rig.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

In some embodiments, any of the methods of the present disclosure may be executed by the controller 106, which may be, be a part or, or include a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis module(s) 702 configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor can include a microprocessor, microcontroller, processor module or subsystem, programmable integrated circuit, programmable gate array, or another control or computing device.

The storage media 706 can be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 700 contains one or more water detection module(s) 708. In the example of computing system 700, computer system 701A includes the water detection module 708. In some embodiments, a single water detection module may be used to perform some or all aspects of one or more embodiments of the methods. In alternate embodiments, a plurality of water detection modules may be used to perform some or all aspects of methods.

It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A lubricant system for providing a lubricant to a machine, the system comprising:
one or more sensors configured to measure a physical property of the lubricant system; and
a controller in communication with the one or more sensors, wherein the controller is configured to:
receive measurements of the physical property from the one or more sensors;
determine an operating state of at least a portion of the lubricant system based at least in part on the measurements of the physical property; and
determine a presence of water in the lubricant based at least in part on the measurements of the physical property.

2. The system of claim 1, further comprising a lubricant pump configured to pump the lubricant through the lubricant system, wherein:
the one or more sensors comprise a first pressure sensor,
the physical property is a pressure of the lubricant,
the operating state is a level of lubricant in the lubrication system, and
the controller is configured to determine the presence of water based at least partially on a difference between an expected pressure and the pressure measured by the first pressure sensor.

3. The system of claim 2, wherein the controller is configured to determine the presence of water based on a difference between the pressure measured by the first pressure sensor when the lubricant pump is not operating and the expected pressure.

4. The system of claim 1, further comprising:
a lubricant pump configured to pump lubricant through the lubrication system; and
a filter configured to filter the lubricant pumped from the lubricant pump,
wherein the one or more sensors comprise a first pressure sensor configured to measure lubricant pressure upstream of the filter, and a second pressure sensor configured to measure lubricant pressure downstream of the filter, wherein the physical property that is measured comprises a pressure differential between pressures measured by the first and second pressures, and wherein the operating state comprises a restriction in the filter.

5. The system of claim 4, wherein the filter is configured to increase the pressure differential between the first and second sensors in response to the presence of water, and wherein the controller is configured to determine the presence of the water based at least in part on the pressure differential increasing caused by the filter.

6. The system of claim 1, wherein the one or more sensors comprises an ammeter coupled to a lubricant pump configured to pump the lubricant in the lubrication system, wherein the physical property that is measured comprises a current draw of the lubricant pump, wherein the operating state comprises power consumption by the lubricant pump, and wherein the controller is configured to determine the presence of the water in the lubricant based at least in part on the measured current draw being different from an expected current draw.

7. The system of claim 6, wherein the controller is configured to vary an operating parameter of the lubricant pump through a plurality of different setpoints, and to compare the measured current draw with the expected current draw at the plurality of different setpoints.

8. The system of claim 1, wherein the controller is configured to calculate a health index for the lubrication system based at least in part on the presence of water.

9. The system of claim 8, wherein the controller is configured to calculate a deterioration rate of the health index and at least one of:
relate the deterioration rate to one or more environmental conditions;
relate the deterioration rate to one or more operating conditions of a lubricant pump;
predict a remaining useful life of the lubricant pump;
schedule a maintenance or replacement operation for the lubricant pump; or
in response to the health index reaching a predetermined minimum, take one or more mitigating actions.

10. A method for detecting water in a lubricant of a lubrication system, the method comprising:
measuring a physical property of the lubricant or a physical property associated with a component of the lubrication system using one or more sensors;
determining an operating state of at least a portion of the lubrication system based at least in part on the measurement of the physical property; and
determining a presence of water in the lubricant based at least in part on the measurement of the physical property.

11. The method of claim 10, wherein the lubrication system comprises a lubricant pump configured to pump the lubricant through the lubricant system, wherein the one or more sensors comprise a first pressure sensor, wherein the physical property is a pressure of the lubricant, and wherein determining the presence of water comprises determining a difference between the measurement of the physical property and an expected pressure of the lubricant.

12. The method of claim 10, wherein the lubrication system further comprises a lubricant pump and a filter configured to filter the lubricant pumped from the lubricant pump, wherein the one or more sensors comprise a first pressure sensor positioned upstream of the filter and a second pressure sensor positioned downstream from the filter, and wherein determining the presence of water comprises:
determining a pressure differential between a pressure measured by the first pressure sensor and a pressure measured by the second pressure; and
determining that the pressure differential is different than an expected pressure differential.

13. The method of claim 12, wherein the filter is configured to increase the pressure differential between the pressures measured by the first and second sensors in response to the presence of water.

14. The method of claim 12, wherein determining the presence of water comprises determining the presence of water based on a difference between the pressure measured by the first pressure sensor when the lubricant pump is not operating and the expected pressure.

15. The method of claim 10, wherein measuring the physical property comprises measuring an electrical current drawn by a lubricant pump that pumps the lubricant in the lubrication system, wherein the controller is configured to determine the presence of the water in the lubricant based on the current drawn by the lubricant pump being different from an expected current draw of the lubricant pump.

16. The method of claim 15, further comprising:
varying an operating parameter of the lubricant pump through a plurality of different setpoints; and
comparing the measured current with the expected current at the plurality of different setpoints.

17. The method of claim 10, wherein determining the presence of the water comprises determining a quantity of water present in the lubricant, the method further comprising calculating a health index for the lubrication system based at least in part on the quantity of water present in the lubricant.

18. The method of claim 17, further comprising calculating a deterioration rate of the health index and at least one of:
relating the deterioration rate to one or more environmental conditions;
relating the deterioration rate to one or more operating conditions of a lubricant pump;
predicting a remaining useful life of the lubricant pump;
scheduling a maintenance or replacement operation for the lubricant pump; or
in response to the health index reaching a predetermined minimum, taking one or more mitigating actions.

19. The method of claim 10, wherein measuring the a physical property comprises measuring at least two types of measurements selected from the group consisting of: a pressure of the lubricant, a pressure differential of the lubricant across a filter, and a current drawn by a lubricant pump of the lubrication system, the method further comprising determining the presence of water based on a combination of the at least two types of measurements.

20. A method for detecting water in a lubricant of a lubrication system, the method comprising:
measuring a pressure of the lubricant in the lubrication system using a first pressure sensor;
measuring a pressure differential of the lubricant in the lubrication system across a filter using the first pressure sensor and a second pressure sensor;
measuring a current draw of a lubricant pump of the lubrication system using an ammeter coupled to the lubricant pump;
comparing the pressure of the lubricant to an expected pressure of the lubricant in the absence of a presence of water in the lubricant;
comparing the pressure differential of the lubricant to an expected pressure differential of the lubricant in the absence of the presence of water in the lubricant;
comparing the current draw of the lubricant pump to an expected current draw of the lubricant pump in the absence of the presence of water in the lubricant;
determining an amount of water in the lubricant based on a combination of the pressure of the lubricant in comparison to the expected pressure, the pressure differential of the lubricant in comparison to the expected pressure differential, and the current draw of the lubricant pump in comparison to the expected current draw; and
taking one or more mitigating actions based at least in part on the determination of the amount of water in the lubricant.
